(19) United States
(12) Patent Application Publication
(10) Pub. No.: US 2026/0135637 A1
(43) Pub. Date: May 14, 2026

(54) DISPLAY DRIVING METHOD AND DISPLAY DRIVING DEVICE

(71) Applicant: LX SEMICON CO., LTD., Daejeon (KR)

(72) Inventors: Yong Sung AHN, Daejeon (KR); Ju Yeob KIM, Daejeon (KR); Hyun Soo LEE, Daejeon (KR); Jun Seong IM, Daejeon (KR); Jae Sik CHO, Daejeon (KR)

(73) Assignee: LX SEMICON CO., LTD., Daejeon (KR)

(21) Appl. No.: 19/118,106

(22) PCT Filed: Sep. 26, 2023
(86) PCT No.: PCT/KR2023/014765

§ 371 Date: Apr. 3, 2025

(30) Foreign Application Priority Data
Oct. 4, 2022 (KR) 10-2022-0126309
Sep. 25, 2023 (KR) 10-2023-0128186

(51) Int. Cl. H04L 1/00; G09G 5/00

(52) U.S. Cl. CPC H04L 1/0045; G09G 5/006; H04L 1/0056; G09G 2370/04; G09G 2370/10

(57) ABSTRACT

A display operation device according to embodiments may comprise: a packet generation unit for generating line packets including control data of a line of a frame, generating frame packets including control data of the frame in a vertical blank, and inserting a pattern into a location which enables a run-length of bits of the frame packets to become a predetermined length or less; and a packet output unit for outputting, to a source driver, the line packets and a frame packet into which the pattern is inserted, wherein the pattern comprises a high component and a low component on a pre-configured bit

### TECHNICAL FIELD

The present disclosure relates to a display driving method and a display driving device.

### BACKGROUND ART

A display device includes a timing controller, a source driver, and a display panel, in which the timing controller may be designed to provide display data, control data, and a clock for display to the source driver in a packet form, the source driver receives the display data and provides a source signal corresponding to the display data to the display panel, and the display panel displays a screen corresponding to the source signal.

The display device requires adoption of technology to reduce power consumption in various elements, and adoption of technology to reduce power consumption at the timing controller and source driver level is being actively considered.

In the conventional method of increasing the toggle rate of data and transmitting configuration data through hamming code and bit swapping methods, there is a problem that encoder and decoder overhead occurs due to such encoding and decoding.

The conventional timing controller transmits frame packets as raw data without scrambling. Because the frame packets include global setting values for the entire frame, there is a problem that it is vulnerable to errors when transmitted as raw data. When error correction or error detection codes are applied to data on the transmission side, there is a problem that a phase difference occurs between data and clock due to bit sequences composed of 0 or 1 having a long length inserted in the data. In addition, there is a limitation that system complexity increases when error correction or error detection codes are applied.

A method for responding to errors occurring in display control data is required in the process of handling packets containing the display control data between the timing controller and the source driver.

In the case where an error occurs in the control data in the process of the timing controller transmitting the control data to the source driver, it is inefficient and has limitations for the timing controller to retransmit the control data to the source driver every time.

Therefore, embodiments propose a method wherein the timing controller inserts patterns at specific positions in the frame packets containing the control data, which is important frame setting information, to secure a minimum run-length, and the source driver determines whether an error has occurred in the frame packets.

### DETAILED DESCRIPTION OF INVENTION

### Technical Problem

The present disclosure is to solve the above-mentioned problems, and has a technical objective of providing a timing controller and a source driver, and a driving method of them, capable of efficiently reading errors occurring in control data.

In addition, the present disclosure has another technical objective of providing a timing controller and a source driver, and a driving method of them, capable of providing a data transmission method that efficiently reduces BER (Bit Error Rate).

### Technical Solution

To achieve the above-mentioned objectives, the display driving device according to embodiments comprises: a packet generator configured to generate line packets containing control data for lines of a frame, generate frame packets containing control data for the frame within a vertical blank, and insert a pattern at a position that makes a run-length of bits of the frame packets be less than or equal to a certain length; and a packet transmitter configured to output the frame packets and the line packets with the inserted pattern to a source driver, wherein the pattern includes high components and low components on a preset bit. The display driving device according to embodiments includes: a packet receiver configured to receive line packets containing control data for lines of a frame and frame packets containing control data for the frame within a vertical blank from a timing controller; and a packet controller configured to detect whether an error has occurred in the frame packets, wherein the frame packets include a pattern at a position that makes the run-length of bits of the frame packets be less than or equal to a certain length, and the pattern includes high components and low components on a preset bit.

### Effect of the Invention

According to the present disclosure, when transmitting control data with high importance between a timing controller and a source driver, the occurrence of errors may be efficiently detected.

Furthermore, without separate encoding and decoding, the hardware overhead of the timing controller and the source driver may be reduced.

Furthermore, there is a technical effect that may prevent the run-length, in which the same value is continuously maintained in the control data, from becoming longer.

### BRIEF DESCRIPTION OF THE DRAWINGS

FIG. 1 illustrates data according to embodiments.

FIG. 2 illustrates a process of inserting a pattern into data according to embodiments.

FIG. 3 and FIG. 4 illustrate a process of detecting errors in data according to embodiments.

FIG. 5 illustrates a method of inserting a pattern into data according to embodiments.

FIG. 6 illustrates a timing controller of a display driving device according to embodiments.

FIG. 7 illustrates a source driver of a display driving device according to embodiments.

### BEST MODE FOR CARRYING OUT THE INVENTION

Throughout the specification, the same reference numerals refer to substantially the same components. In the following description, detailed descriptions of configurations and features known in the art may be omitted if they are not relevant to the core configuration of the present disclosure. Terms used in this specification should be understood as follows.

The advantages and features of the present disclosure, and methods of achieving them will be apparent from the embodiments described in detail below in conjunction with the accompanying drawings. However, the present disclosure is not limited to the following embodiments, but may be implemented in various different forms; rather, the present embodiments are provided to make the description of the present disclosure complete and to allow those skilled in the art to fully understand the scope of the present disclosure, and the present disclosure is defined only within the scope of the appended claims.

Identical reference numerals may designate identical components throughout the description. Further, in describing the present disclosure, detailed descriptions of known related technologies may be omitted if it is considered to unnecessarily obscure the gist of the present disclosure.

The terms such as “comprising,” “including,” “having,” and “consisting of” used herein are generally intended to allow other components to be added unless the terms are used with the term “only.” References to components of a singular noun include the plural of that noun, unless specifically stated otherwise.

When describing a temporal contextual relationship is described, for example, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to herein may also be a second component within the technical idea of the present disclosure.

It should be understood that the term “at least one” includes any combination that can be presented from one or more relevant items. For example, the meaning of “at least one of the first item, the second item, and the third item” may mean each of the first item, the second item, and the third item as well as any combination of items that may be presented from two or more of the first item, the second item, and the third item.

Each of the features of various embodiments of the present disclosure may be coupled or combined with one another in whole or in part, and may be technologically interlocked and operated in various ways, and each of the embodiments may be carried out independently or in conjunction with one another.

Hereinafter, embodiments of the present disclosure will be described in detail with reference to the accompanying drawings.

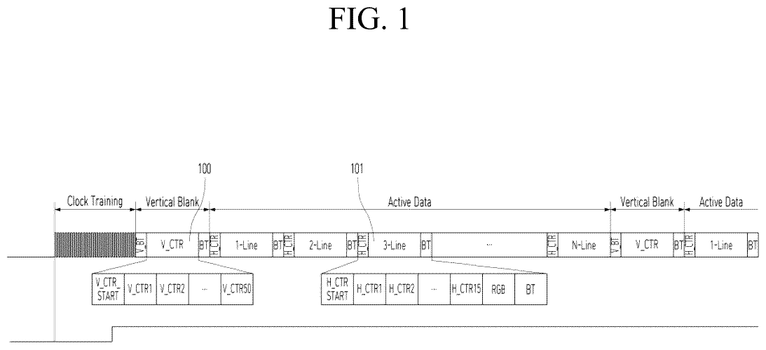

FIG. 1 illustrates data according to embodiments.

FIG. 1 illustrates data generated by a timing controller of a display driving device according to embodiments and received by a source driver from the timing controller. A packet generator 600 of the timing controller generates the data, and a packet transmitter 601 of the timing controller transmits the data to the source driver. A packet receiver 700 of the source driver receives the data.

The data includes frame packets 100 and line packets 101. The frame packets 100 include a frame packet start indicator V_CTR_START, and the frame packets 100 may comprise a plurality of frame packets (V_CTR fields) including frame control data. The line packets 101 include a line packet start indicator H_CTR_START, and the line packets 101 may comprise a plurality of line packets (H_CTR fields) including RGB data.

The frame packets 100 include control data (Control Data or Configuration Data) in units of frames. The frame packets 100 are packets that include control data for each frame. Among a plurality of frames, the first frame includes active data, and control packets including frame-specific control data may be located in front of the first frame as a vertical blank. For example, the frame packets may include frame-specific brightness information, power consumption information, and information related to display mode such as low power mode information, normal mode information, and so on. The first frame packets may be transmitted after a signal for clock training. The source driver that receives the frame packets from the timing controller may display active data (RGB) based on the control data for the corresponding frame. Depending on the display environment, the active data may be displayed in low power or normal mode.

If an error occurs in the control data of the frame packets 100, it is difficult to retransmit the frame packets 100, and it is difficult to apply scrambling for error reading.

The active data area of the frame may include data for a plurality of lines. Each line may include a plurality of line packets. The line packets 101 include control data (Control Data or Configuration Data) per line. For example, the line packets may include line-specific data size information and so on. Even if an error occurs in the line packets 101, retransmitting the line packets 101 is relatively easier than retransmitting the frame packets 100.

In the case of control data included in the frame packets 100, if the timing controller scrambles the control data and transmits it for error reading, it is difficult for the source driver to read the control data of the frame packets 100. If the transmission side scrambles the data, there is a burden that the reception side must descramble the received data. Also, if even one bit of the control data is lost during transmission and reception, an error occurs during frame setting. The conventional timing controller transmits the frame packets without scrambling, as raw data. Since the frame packets include global setting values for the entire frame, there is a problem that it is vulnerable to errors when transmitted as raw data. When error correction or error detection codes are applied to data on the transmission side, there is a problem that a phase difference occurs between data and clock due to bit sequences composed of 0 or 1 having a long length inserted in the data. In addition, there is a limitation that system complexity increases when error correction or error detection codes are applied.

Therefore, embodiments propose a method wherein the timing controller according to embodiments inserts a pattern at specific positions in the frame packets containing the control data, such as important frame setting information, to secure a minimum run-length, and the source driver determines whether an error has occurred in the frame packets.

Referring to FIG. 1, when generating data to be transmitted to the source driver as packets, the timing controller may generate line packets containing control data for lines of a frame, and generate frame packets containing control data for the frame within a vertical blank. By transmitting the frame packets at the timing of the vertical blank before transmitting the line packets containing the actual data, the control data necessary to display each frame may be delivered to the source driver. If separate encoding and decoding are applied to the frame packets, there is a problem that the system overhead increases, and the display is delayed due to the encoding time on the transmission side and the decoding time on the reception side. Therefore, by transmitting a pattern inserted in the frame packets according to the method of the embodiments, there is an effect of detecting errors with low latency.

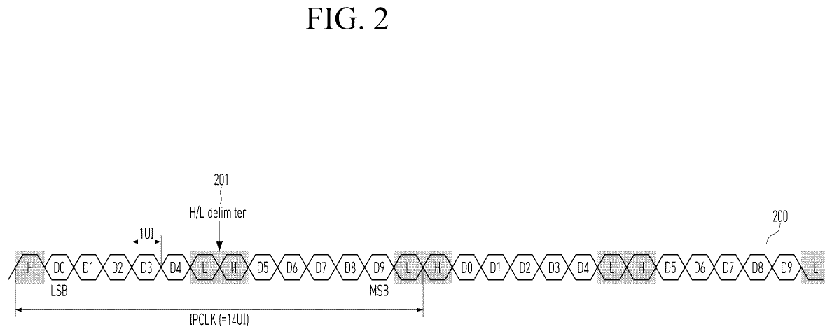

FIG. 2 illustrates a process of inserting patterns into packets according to embodiments.

FIG. 2 illustrates a process in which the packet generator 600 of the timing controller generates a specific data pattern and inserts it into packets in the process of generating the data of FIG. 1. The control packets into which the specific data pattern is inserted may be the frame packets 100 (hereinafter, ‘control packets’) of the data of FIG. 1. The data corresponding to 1PCLK (14 UI) in FIG. 2 may correspond to the frame packets V_CTR in FIG. 1. An H/L pattern 201 may be included at specific positions of the 10-bit length data from D0 to D9 on 14UI. D0 is the LSB (least significant bit) and D9 is the MSB (most significant bit), and the LSB and MSB positions (order) may be changed according to the settings of the timing controller and the source driver. Before D0 and after D9, a delimiter 1 bit (UI) such as H or L may be included to distinguish between frame packets (V_CTR). 1PCLK may be 14UI or 20UI depending on the settings of the timing controller and the source driver. The method of inserting a pattern into frame packets is described below.

In the process of transmitting control data between the timing controller and the source driver, to enhance the function of detecting bit errors in terms of BER (bit error rate), the timing controller may insert a specific data pattern 201 at the middle or arbitrary points of the bits of the control data of the control packets 200. The specific data pattern 201 according to embodiments may consist of 0 and 1. The 0 constituting the specific data pattern 201 may be referred to as low, and the 1 may be referred to as high. The specific pattern 201 consisting of 0 and 1 may be referred to as an H/L delimiter. Assuming that the control data (10 bits indicated by D0 to D9) included in the control packets, which are the frame packets 100 of FIG. 2, are 1PCLK of 14UI, the packet generator 600 of the timing controller may insert a 0 bit that is low (L) and a 1 bit that is high (H) in the middle every 5 bits. D0 is the LSB (Least Significant Bit) and D9 is the MSB (Most Significant Bit).

A run-length refers to the number of bits that continuously maintain the same value. Embodiments may provide a high-speed interface by limiting the run-length. By inserting an H/L delimiter 200 in the middle or arbitrary positions of the data, there is an effect of preventing the run-length of the data from becoming longer. Also, there is an effect of quickly and efficiently detecting the presence or absence of errors in the control data through the data checksum process.

Regarding H/L delimiter insertion, the packet generator 600 of the timing controller may insert an H/L delimiter at a specific position of the bits included in the frame packets. For example, referring to FIG. 2, if the control data has a length of 10 bits, an H/L delimiter may be inserted between the 5th bit and the 6th bit so that the control data has a run-length of 5 bits. When the H/L delimiter is inserted at the middle position of the control data, the value of the run-length becomes the maximum. The timing controller may determine the insertion position of the H/L delimiter so that the value of the run-length becomes smaller according to the BER (bit error rate). For example, an H/L delimiter may be inserted in the control data so that the run-length is less than 5. The position where the pattern is inserted may be determined as a position that makes the run-length of the bits smaller than a certain length.

As described above, if the control packets are scrambled for error reading, it is difficult to read the control data included in the control packets. Also, if even one bit of the control data is lost, the display setting due to the control data may be incorrect. Therefore, in the case of control data, instead of scrambling, it is transmitted as raw data itself, but raw data has a problem that the run-length becomes longer. Therefore, the timing controller may insert a pattern after a certain number of data bits as shown in FIG. 2. For example, if a pattern (L/H delimiter) consisting of 0 and 1 is inserted after 5 bits of data, the minimum run-length may be 6 or less.

The timing controller may efficiently detect whether an error has occurred in the frame packets by inserting a pattern that limits the bit run-length of the data of the frame packets as shown in FIG. 2. Clock delays in the encoder and decoder may occur when performing error encoding/decoding, but the embodiments have the effect of reducing system overhead because the timing controller does not perform separate encoding to detect error occurrence and the source driver does not require separate decoding, resulting in the effect of low latency display without display delay due to separate encoding/decoding performance.

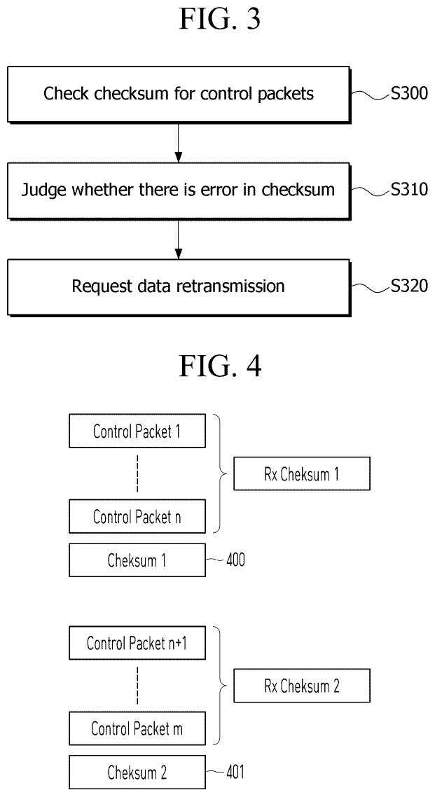

Hereinafter, the process of detecting data errors through specific pattern insertion is described in FIG. 3 and FIG. 4.

FIG. 3 and FIG. 4 illustrate a process of detecting errors in data according to embodiments.

When the timing controller inserts high and low patterns into the control data as shown in FIG. 2 and transmits it to the source driver, the source driver may determine whether an error has occurred in the control data received from the timing controller as shown in FIG. 3 and FIG. 4.

The packet generator 600 of the timing controller generates control packets with patterns inserted as shown in FIG. 2, and may generate a checksum for the patterns for error reading and transmit the checksum to the source driver along with the control packets. Referring to FIG. 4, the checksum, which is the sum of the patterns 201 included in the first control packet to the (n)th control packet, may be calculated and the calculated checksum 400 may be inserted and transmitted after the (n)th control packet.

The source driver may receive the checksum 400 and detect whether an error has occurred in the first control packet to the (n)th control packet.

Similarly, the checksum, which is the sum of the patterns included in the (n+1)th control packet to the (m)th control packet, may be calculated and the calculated checksum 401 may be inserted after the (m)th control packet and transmitted.

The source driver may receive the checksum 401 and detect whether an error has occurred in the first control packet to the (n)th control packet.

The packet generator 600 of the timing controller transmits a packet sequence including a certain number of control packets for error reading and a checksum of the patterns included in the control packets to the packet receiver 700 of the source driver.

The packet generator 600 of the timing controller may group a certain number of control packets 100 and 200 and insert a checksum for the grouped packets after the grouped frame packets. The checksum may be calculated from bits including the inserted pattern, or from bits that are not the inserted pattern, or from bits that include only part of the inserted pattern.

Meanwhile, the number of control packets that are grouped may be variously set according to the interface environment and the type of data. For example, if the data is frame packets, since it is difficult to read control data during scrambling, frequent retransmission is difficult, and it is important to detect errors in control data, the grouping number may be made small for important control data to increase the checksum process. In the case of line packets, error reading processing may be applied through scrambling, and since it is easy to request retransmission even if an error occurs in the line packets, the grouping number may be large and the checksum process may be fewer.

The error judgment method of the source driver may include a step of checking the checksum for the control packets (S300), a step of judging whether there is an error in the checksum (S310), and a step of requesting data retransmission (S320).

Step of checking the checksum for the control packets (S300): The packet receiver 700 of the source driver receives control packets with patterns inserted as shown in FIG. 2, and may check the checksum of the received patterns.

Step of judging whether there is an error in the checksum (S310): The packet receiver 700 or the packet controller 701 of the source driver may calculate a checksum for the received control data group. For example, it may calculate a checksum (hereinafter, RX checksum 1) which is the sum of the patterns included in the received first control packet to the (n)th control packet. Furthermore, it compares the checksum 400 (hereinafter, checksum 1) located after the received (n)th control packet with RX checksum 1. The source driver may check whether an error has occurred in the received control packets by comparing RX checksum 1 calculated directly from the received control data and checksum 1 calculated by the timing controller.

Similarly, it may calculate a checksum (hereinafter, RX checksum 2) included in the received (n+1)th control packet to the (m)th control packet. Furthermore, it compares the checksum 401 (hereinafter, checksum 2) located after the received (n)th control packet with RX checksum 2. The source driver may check whether an error has occurred in the received control packets by comparing RX checksum 2 calculated directly from the received control data and checksum 2 calculated by the timing controller.

Step of requesting data retransmission (S320): The packet controller 701 of the source driver may detect an error if an error occurs in the control data received from the timing controller by the packet receiver 700 of the source driver, stop receiving control data from the timing controller, and determine whether to request retransmission. As described above, it recognizes an error through comparison between RX checksum 1 and checksum 1, and increases the count indicating the number of errors. That is, if the value of RX checksum 1 and the value of checksum 1 are different from each other, it may be recognized that an error has occurred in the packet during transmission. In addition to the method of detecting an error whenever the comparison values are different, a reference value for determining the final error occurrence may be set. The value of the count indicating the number of errors may be compared with a threshold value. Here, the threshold value is a threshold value for determining whether to request retransmission due to an error, which is a value set by the source driver. If the count is greater than the threshold value, the packet controller 701 may stop the control data reception of the packet receiver 700 and request the timing controller to retransmit the control data in which an error has occurred. The source driver may turn off the control signal for receiving data from the timing controller, (hereinafter, lock2), stop the data transmission of the timing controller, and request to retransmit the data of FIG. 2. On the contrary, if the count is smaller than the threshold value, the source driver may not request data retransmission to the timing controller.

In other words, the timing controller (Tx) transmits the control data of FIG. 2 to the source driver (Rx) when lock2 is high, and does not transmit control data when lock2 is low. The correct answer for checksum is sent to the last packet position or arbitrarily set packet positions among the control packets, and this is compared with the result of calculating the checksum of the control packets transmitted in the source driver (Rx) to detect which packet group has an error, and the value of the count is recorded in the register of the source driver. If the error count value exceeds the threshold, the frame including the packet where the error occurred is deleted and the host timing controller is requested to retransmit the data.

Additionally, the packet controller 701 may variously set the pattern comparison target for error detection. Instead of comparing checksums for all patterns inserted in the data, the patterns (/L delimiter) inserted for each data packet of a certain length included in the data may be compared, and if a pattern different from the inserted pattern is detected, it may be determined that an error has occurred in the control packet group for the different pattern. For example, if a high/low pattern is inserted into the control packets, and the inserted pattern for each data packet of a certain length is low/high instead of high/low, the source driver may confirm that an error has occurred in the control packets of that length.

According to embodiments, the packet generator 600 of the timing controller may insert a high/low pattern into the control packets, and additionally, scramble the high/low pattern. Also, since the run-length may increase if only the pattern of the order of 0 and 1, which is high/low, is inserted into the control packets, in order to maintain the run-length at 6 bits or less as much as possible, when inserting the high/low pattern, a pattern of 01 may be applied, and a pattern of 10 may be applied by changing the order of the pattern. Also, in the case of line packets, high/low patterns may be used differently for each line. For example, a pattern of 01 may be inserted in the first line, and a pattern of 10 may be inserted in the second line. The high/low pattern may be 2 bits like 01 and 10. Furthermore, high/low patterns may be generated and inserted as 3 bits, 4 bits, and so on.

The area of packets for calculating the checksum for a plurality of control packets on the transmission (Tx) side may be set in various forms and multiple areas, including the control packets and the high/low pattern inserted in the control packets. Also, in the checksum calculation process, the target of the checksum may be the high/low pattern, or the data of the control packets including the high/low pattern, or the data of the control packets excluding the high/low pattern, and/or the data of the control packets including only part of the high/low pattern. Also, in the checksum calculation process, the bits that are the target of the checksum may be grouped, and a checksum for the grouped bits may be calculated. For example, MSB and/or LSB may be located in the data of the control packets, and checksums may be calculated separately for each of MSB and LSB.

The control packets of the data transmitted by the packet transmitter 601 of the timing controller may be configured according to importance and/or purpose. Also, a plurality of checksums may be supported for each area of the control packets, and it may be decided whether to activate or deactivate the checksum for each area. This is to efficiently apply checksums according to the importance and/or purpose of the data of the control packet. Also, the threshold value for the error count may be set differently according to the importance of the packet transmitted by the timing controller. For example, the frame packets may include more important control data than the line packets. Therefore, for the V-CTR of the frame packets with high importance, the threshold value for the error count may be set to a small value, so that the source driver is configured to detect an error even at a small threshold value, stop the transmission of the control packets, and make the timing controller retransmit the control packet. In the case of line packets that include control data of lower importance than the frame packets, the threshold value for the error count for the H-CTR may be set to a larger value than the threshold value for the error count of the V-CRT.

As described above, in the data transmission between the timing controller and the source driver (D-IC), to improve the BER, a pattern (pattern (H/L delimiter)) containing 0 and 1 is inserted at the middle or arbitrary points of the control (configuration) data packets to prevent the run-length from becoming longer, and errors in the control packets may be detected through data checksum. If encryption or encoding is applied for error detection of data, there is a problem that the overhead of the encoder on the transmission side increases, and similarly, there is a problem that the overhead of the decoder for decoding on the reception side increases, but the embodiments have an effect of efficiently detecting errors without increasing system overhead.

According to embodiments, the definition of checksum (checksum, 400) and received checksum (Rx checksum) may be diverse. In the process where the timing controller generates a checksum on the transmission side and inserts it into frame packets, and the source driver calculates a checksum inserted in the received frame packets from the received frame packets, the checksum and received checksum may be the sum of the values of the patterns inserted in the frame packets as described above. Also, the checksum and received checksum may be the sum of the valid data included in the frame packets, excluding the patterns inserted in the frame packets. Also, the checksum and received checksum may be the sum of values including both the pattern and valid data included in the frame packets. The definition of the checksum that the timing controller calculates, inserts, and transmits, and the received checksum that the reception driver calculates from the received frame packets may be set as one of the above examples according to the settings between the timing controller and the reception driver.

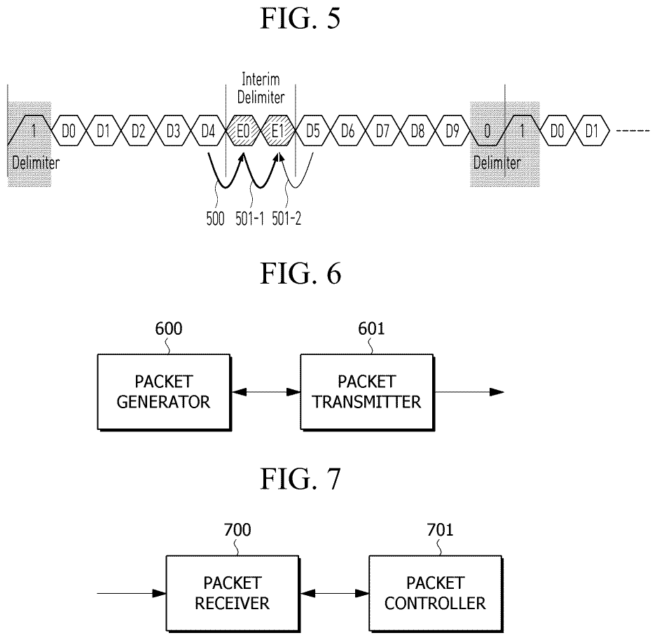

FIG. 5 illustrates a method of inserting a pattern into data according to embodiments.

FIG. 5 illustrates an additional pattern insertion method related to the pattern insertion method described in FIG. 2. When the packet transmitter 601 of the timing controller (Tx) transmits control packets to the packet receiver 700 of the source driver, in order to reduce the run-length (or to maintain the minimum run-length at 6 or less), the high/low pattern may be determined based on the value of the control data, rather than inserting a high/low pattern with a fixed value. For example, referring to FIG. 5, when inserting a high/low pattern between control data D4 and control data D5, if the high/low pattern is referred to as E0 and E1, if D4 is 1, E0 is set to 0, opposite to D4. If D4 is 0, E0 is set to 1 (500). E1 is set to the opposite value of E0. If E0 is 0, E1 is set to 1, and if E0 is 1, E1 is set to 0(501-1). Or E1 is set to the opposite value of D5 (501-2). That is, because the values between D4, E0, E1, and D5 may continue to change, there is an effect that the toggle rate effect is improved and the run-length becoming longer is prevented.

When the source driver (Rx) checks the received control packets, it may check whether D4 and E0 are the same or different by XORing them. By checking whether D4⊕E0=1 or D4⊕E0=0, it is possible to check whether there is damage or error in the packet transmission process. If D4 and E0 have different bits from each other, it may be known that there is no error in the transmission process, and if D4 and E0 have the same bits, it may be known that an error has occurred in the transmission process. Similarly, if opposite bit values are inserted in E0 and E1, the source driver may XOR E0 and E1 to check whether the two values are different or the same. By checking whether E1⊕E0=1 or E1⊕E0=0, it is possible to check whether there is damage or error in the packet transmission process. Also, in the case where opposite bit values are inserted in E1 and D5, the presence or absence of packet damage may be checked in the same way as above.

Additionally, as in FIG. 5, the pattern is not only composed of 2 bits like E0, E1, but the timing controller may insert a pattern into the control data with 3 bits like E0, E1, E2. If one cycle of the control data packet is 14 bits (14UI), as shown in FIG. 5, a pattern may be inserted at the middle position on the data as an interim delimiter.

FIG. 6 illustrates a timing controller of a display driving device according to embodiments.

FIG. 6 illustrates a timing controller of a display driving device that performs the operations according to the embodiments described above. The timing controller includes a packet generator 600 and a packet transmitter 601. The packet generator 600 and the packet transmitter 601 may correspond to hardware, software, or a processor.

The packet generator 600 may generate control packets containing control data as shown in FIG. 1. The packet generator 600 may insert a pattern into the control data as shown in FIG. 2 and FIG. 5. The packet control generator 600 may generate frame packets for each frame and line packets for each line. The packet control generator 600 may insert a specific pattern at a position where the bit of the control data included in the frame packets has a run-length less than or equal to a certain value for error reading of the control data. Regarding the structure of the packet generated by the packet generator 600, the description of FIG. 1 to FIG. 2 should be referred.

The packet transmitter 601 may transmit the control data generated as shown in FIG. 1 to FIG. 2 to the source driver (FIG. 7). The packet transmitter 601 may output frame packets and line packets. The packet transmitter 601 may output frame packets for the first frame generated within the vertical blank based on clock training, and output line packets for each line to deliver active data for the first frame.

FIG. 7 illustrates a source driver of a display driving device according to embodiments.

FIG. 7 illustrates a source driver of a display driving device that performs the operations according to the embodiments described above. The source driver includes a packet receiver 700 and a packet controller 701. The packet receiver 700 and the packet controller 701 may correspond to hardware, software, or a processor.

The packet receiver 700 receives control data generated as shown in FIG. 1, FIG. 2, and FIG. 5 from the timing controller of FIG. 6.

The packet controller 701 determines whether an error has occurred on the control data received by the packet receiver 700, and requests the timing controller to stop data transmission when an error occurs. Furthermore, it may request data retransmission to the timing controller. The packet controller 701 may detect whether an error has occurred in the control data as described in FIG. 3, FIG. 4, and FIG. 5.

Regarding the timing controller of the display driving device, referring to FIG. 6, FIG. 1, FIG. 2, and so on., it includes: a packet generator that generates frame packets containing control data for a frame, inserts a pattern at a middle position of the control data so that the run-length of the control data of the frame packets is less than or equal to a certain length, and generates line packets containing control data for a line; and a packet transmitter that outputs the frame packets with the inserted pattern and the line packets to a source driver; wherein the pattern may include high components and low components on at least 2 bits.

Regarding the operation of detecting errors through checksum, referring to FIG. 4, the packet generator calculates a checksum which is the sum of the patterns inserted in a certain number of frame packets among the frame packets, inserts the checksum after the certain number of frame packets, and the packet transmitter may transmit the frame packets containing the inserted checksum.

Referring to FIG. 5, regarding the method of configuring high(1)/low(0) in the pattern, in the case where the pattern is 2 bits, if the bit of the data located in front of the pattern is 0, the first bit of the pattern is 1 and the second bit of the pattern is 0, and if the bit of the data located in front of the pattern is 1, the first bit of the pattern is 0 and the second bit of the pattern is 1, or if the bit of the data located after the pattern is 0, the second bit of the pattern is 1 and the first bit of the pattern is 0, and if the bit located after the pattern is 1, the second bit of the pattern is 0 and the first bit of the pattern is 1. Similarly, in the case where the pattern is 3 bits, the components constituting the pattern may be inserted so that components that are opposite, such as high/low, are arranged.

Regarding the number of control packets that are the target of the checksum, for control data with high importance, the number of bits in the bit group may be set small, so that the checksum may be checked frequently. For example, the number of control packets for a checksum for control packets containing control data for a frame may be made more than the number of control packets for a checksum for control packets containing control data for a line.

Regarding the error detection method using pattern, if the value of a first pattern among the patterns inserted in the frame packets and the value of a second pattern located after (subsequently transmitted and received) the first pattern are different, it may be detected that an error has occurred in the frame packets in which the second pattern is inserted.

Regarding error detection using both pattern and checksum, if the sum of the patterns inserted in a certain number of frame packets output from the packet transmitter is different from the checksum, the value of the error count for detecting error occurrence in a certain number of frame packets is increased, and if the value of the error count is greater than the threshold value, it may be detected that an error has occurred in a certain number of frame packets.

For example, if a checksum, which is the sum of the pattern of the first frame packet and the pattern of the second frame packet, is inserted and transmitted after the second frame packet, the source driver calculates the sum of the pattern of the received first frame packet and the pattern of the third frame packet, and may compare it with the value of the received checksum. Since the received checksum is the correct answer for the received pattern, if the sum between patterns calculated by the source driver is different from the received checksum, it may be known that an error has occurred in the transmission process of the first frame packet and the second frame packet.

Also, since requesting retransmission of the frame packets with only one checksum comparison may cause system burden, the source driver may set a threshold value for final error judgment. Furthermore, by increasing the count value by 1 each time the received checksum and the calculated sum of the pattern are different from each other, if the increased count value becomes larger than the threshold value, it may detect that an error has occurred in the frame packets transmission process, and in order to reset the frame, it may stop the transmission of the vertical frame including the frame packets and request retransmission to the timing controller.

Regarding the source driver of the display driving device, referring to FIG. 7, the display driving device includes: a packet receiver that receives, from a timing controller, frame packets containing control data for a frame and line packets containing control data for a line; and a packet controller that detects whether an error has occurred in the frame packets; wherein the frame packets include a pattern at a middle position of the control data so that the run-length of the control data of the frame packets is less than or equal to a certain length, and the pattern may include high components and low components on at least 2 bits.

Referring to FIG. 3 to FIG. 4, the packet receiver further receives a checksum which is the sum of the patterns inserted in a certain number of frame packets among the frame packets, wherein the checksum may be received while being inserted after a certain number of frame packets.

Regarding the error detection method using pattern, referring to FIG. 4, the packet controller may detect that an error has occurred in the frame packets in which the second pattern is inserted if the value of a first pattern among the patterns inserted in the frame packets and the value of a second pattern located after the first pattern are different.

Regarding the error detection method using checksum, the packet controller calculates a checksum which is the sum of the patterns inserted in a certain number of frame packets, and the packet controller increases the value of the error count for detecting error occurrence for a certain number of frame packets if the value of the received checksum is different from the value of the calculated checksum, and if the value of the error count is greater than the threshold value, it detects an error for a certain number of frame packets, and may request retransmission of the frame packets to the timing controller.

According to the embodiments, when transmitting control data with high importance between a timing controller and a source driver, the occurrence of errors may be efficiently detected. Also, without separate encoding and decoding, the hardware overhead of the timing controller and the source driver may be reduced. Also, it is possible to prevent the run-length, in which the same value is continuously maintained in the control data, from becoming longer.

Those skilled in the art to which the present disclosure belongs will understand that the present disclosure described above may be implemented in other specific forms without changing its technical idea or essential features.

In addition, the methods described herein may be implemented, at least in part, using one or more computer programs or components. The component may be provided as a set of computer instructions on a computer-readable medium including volatile and non-volatile memory or a machine-readable medium. The above instructions may be provided as software or firmware and may be implemented, in whole or in part, in hardware configurations such as ASICs, FPGAs, DSPs, or other similar devices. The above instructions may be configured to be executed by one or more processors or other hardware configurations, which, when executing the above set of computer instructions, perform or cause to be performed all or a portion of the methods and procedures disclosed herein.

The present disclosure described above is not limited to the foregoing embodiments and the accompanying drawings, and it will be apparent to a person skilled in the art to which the present disclosure belongs that various substitutions, modifications, and changes may be made within the scope without departing from the technical spirit of the present disclosure. Therefore, the scope of the present disclosure is represented by the following claims, and it should be construed that all changes or modifications derived from the meaning and scope of the claims and the equivalent concept thereof are included within the scope of the present disclosure.

### Mode of Practing the Invention

As described above, related contents for implementing embodiments have been described in the best mode.

### INDUSTRIAL APPLICABILITY

As described above, the embodiments may be applied, in whole or in part, to the display driving method and apparatus.

Those skilled in the art may make various changes or modifications to the embodiments within the scope of the disclosure.

The embodiments may include modifications/variations, which modifications/variations do not depart from the scope of the claims and the equivalents thereof.

1. A display driving device comprising:
a packet generator configured to generate line packets containing control data for lines of a frame, generate frame packets containing control data for the frame within a vertical blank, and insert a pattern at a position that makes a run-length of bits of the frame packets be less than or equal to a certain length; and
a packet transmitter configured to output the frame packets and the line packets with the inserted pattern to a source driver,
wherein the pattern includes high components and low components on a preset bit.

2. The display driving device according to claim 1, wherein the packet generator is configured to:
calculate a checksum which is a sum of patterns inserted in a certain number of frame packets among the frame packets, and
insert the checksum after the certain number of frame packets, and
wherein the packet transmitter is configured to transmit the frame packets containing the inserted checksum.

3. The display driving device according to claim 2, wherein:
if the sum of the patterns inserted in the certain number of frame packets output from the packet transmitter is different from the checksum, a value of the error count for detecting error occurrence in the certain number of frame packets is increased, and
if the value of the error count is greater than a threshold value, it is detected that an error has occurred in the certain number of frame packets.

4. The display driving device according to claim 1, wherein if a value of a first pattern among the patterns inserted in the frame packets and a value of a second pattern located after the first pattern are different, it is detected that an error has occurred in the frame packets in which the second pattern is inserted.

5. The display driving device according to claim 1, wherein in a case where the pattern is 2 bits,
if a bit of data located in front of the pattern is 0, a first bit of the pattern is 1 and a second bit of the pattern is 0, and if the bit of the data located in front of the pattern is 1, the first bit of the pattern is 0 and the second bit of the pattern is 1, or
if a bit of data located after the pattern is 0, a second bit of the pattern is 1 and a first bit of the pattern is 0, and if a bit of the data located after the pattern is 1, the second bit of the pattern is 0 and the first bit of the pattern is 1.

6. A display driving device comprising:
a packet receiver configured to receive line packets containing control data for lines of a frame and frame packets containing control data for the frame within a vertical blank from a timing controller; and
a packet controller configured to detect whether an error has occurred in the frame packets,
wherein the frame packets include a pattern at a position that makes a run-length of bits of the frame packets be less than or equal to a certain length, and
the pattern includes high components and low components on a preset bit.

7. The display driving device according to claim 6, wherein the packet receiver is further configured to receive a checksum which is a sum of patterns inserted in a certain number of frame packets among the frame packets, and
wherein the checksum is inserted after the certain number of frame packets.

8. The display driving device according to claim 6, wherein in a case where the pattern is 2 bits,
if a bit of data located in front of the pattern is 0, a first bit of the pattern is 1 and a second bit of the pattern is 0, and if the bit of the data located in front of the pattern is 1, the first bit of the pattern is 0 and the second bit of the pattern is 1, or
if a bit of data located after the pattern is 0, a second bit of the pattern is 1 and a first bit of the pattern is 0, and if the bit of the data located after the pattern is 1, the second bit of the pattern is 0 and the first bit of the pattern is 1.

9. The display driving device according to claim 6, wherein the packet controller is configured to detect that an error has occurred in the frame packets in which a second pattern is inserted if a value of a first pattern among the patterns inserted in the frame packets and a value of the second pattern located after the first pattern are different.

10. The display driving device according to claim 7, wherein the packet controller is configured to calculate a checksum which is a sum of the patterns inserted in the certain number of frame packets,
the packet controller is configured to increase the value of the error count for detecting error occurrence for the certain number of frame packets if a value of the received checksum is different from a value of the calculated checksum, and
the packet controller is further configured to, if the value of the error count is greater than a threshold value, detect an error for the certain number of frame packets, and request retransmission of the frame packets in which the error is detected to the timing controller.
